(19) United States
(12) Patent Application Publication
(10) Pub. No.: US 2024/0363967 A1
(43) Pub. Date: Oct. 31, 2024

(54) SEPARATOR, METHOD FOR MANUFACTURING THE SAME, AND SECONDARY BATTERY INCLUDING THE SAME

(71) Applicants: SK INNOVATION CO., LTD., Seoul (KR); SK IE TECHNOLOGY CO., LTD., Seoul (KR)

(72) Inventors: Sang Yoon JI, Daejeon (KR); Jun Hwan AHN, Daejeon (KR); Chang Hee LEE, Daejeon (KR); Jun Hyung KIM, Daejeon (KR)

(21) Appl. No.: 18/644,956

(22) Filed: Apr. 24, 2024

(30) Foreign Application Priority Data
Apr. 27, 2023 (KR) 10-2023-0055185

(51) Int. Cl. H01M 50/451; H01M 50/403; H01M 50/414; H01M 50/434; H01M 50/443; H01M 50/491

(52) U.S. Cl. CPC H01M 50/451; H01M 50/403; H01M 50/414; H01M 50/434; H01M 50/443; H01M 50/491

(57) ABSTRACT

Separators, methods for manufacturing the separators, and secondary batteries including the separators are disclosed. In one embodiment, a separator may include a porous substrate including a first surface and a second surface, and a coating layer disposed on at least one of the first surface or the second surface of the porous substrate and including inorganic particles and hollow adhesive particles.

### PRIORITY CLAIM AND CROSS-REFERENCE TO RELATED APPLICATIONS

This patent document claims the priority and benefits of Korean Patent Application No. 10-2023-0055185, filed on Apr. 27, 2023, the disclosure of which is incorporated herein by reference in its entirety.

### TECHNICAL FIELD

The disclosed technology relates to a separator, a method for manufacturing the separator, and a secondary battery including the separator.

### BACKGROUND

Recently, secondary batteries are becoming higher capacity and larger in order to be applied to electric vehicles. To this end, electrodes and separators are stacked and integrated together to form an electrode-separator combination structure.

### SUMMARY

The disclosed technology can be implemented in some embodiments to provide a separator including hollow adhesive particles, a method for manufacturing the separator including hollow adhesive particles, and a secondary battery including the separator including hollow adhesive particles. In an embodiment of the disclosed technology, a separator may be attached to an electrode with high adhesive strength using only a small amount of adhesive material. The separator of the present invention can be used in a secondary battery.

In another embodiment of the disclosed technology, a separator may internally accommodate expansion and prevent swelling caused by an electrolyte while providing an adhesive function of the separator.

In another embodiment of the disclosed technology, a method for manufacturing a separator may be performed without forming a separate adhesive layer, and thus a separator having improved adhesive strength to an electrode may be produced through a simple process. In some embodiments, in the process of forming a coating layer by applying a coating composition including inorganic particles and hollow adhesive particles, the hollow adhesive particles, which have a lower specific gravity than the inorganic particles, float to form an adhesive layer, and thus, a desired electrode adhesive strength can be achieved by a single application process without the need for separate application processes for forming an adhesive layer. In another embodiment of the disclosed technology, a separator may use a lower content of hollow adhesive particles than when forming a separate adhesive layer. The separator may have excellent electrode adhesive strength even with a lower content as compared to the conventional case.

In another embodiment of the disclosed technology, a separator may include hollow adhesive particles that function as a buffer to internally accommodate swelling caused by an electrolyte, thereby suppressing swelling and elution of the electrolyte.

In another embodiment of the disclosed technology, a separator may suppresses swelling and exhibit excellent adhesive strength, and thus alignment can be maintained even when multiple electrodes and separators are stacked. In some embodiments, a battery may include the separator.

In another embodiment of the disclosed technology, a secondary battery may include a separator with improved adhesive strength, enabling a higher capacity and a larger size.

In one general aspect, a separator includes: a porous substrate; and a coating layer which is placed on one or both surfaces of the porous substrate and includes inorganic particles and hollow adhesive particles. For example, a separator may include a porous substrate including a first surface and a second surface, and a coating layer disposed on at least one of the first surface or the second surface of the porous substrate and including inorganic particles and hollow adhesive particles.

The coating layer may be either directly placed on said surface of said porous structure. Or it may be indirectly placed on said surface of said porous structure, meaning that there may be a further inorganic particle layer between said surface of the porous substrate and the coating layer; this further (or additional) inorganic particle layer, which may be further included between the porous substrate and the coating layer but may not include the hollow adhesive particles, refers to a layer formed of inorganic particles commonly used in the art of separators suitable for batteries, such as the ceramic coating (inorganic particle layer) of conventional ceramic-coated separators (CCS).

In an example embodiment, when a surface of the coating layer facing the porous substrate is referred to as a first surface and an opposite surface of the first surface is referred to as a second surface, the second surface may have a higher content (amount) of the hollow adhesive particles than the first surface.

The respective amount (content) of said first surface and of said second surface of the hollow adhesive particles can be determined by any suitable method that is known to a skilled person. In the present invention, the following method was applied: By applying focused ion beam milling (FIB), the coating of the separator was cut, thereby obtaining a cross-section of the coating. Then, the distribution of the hollow adhesive particles in the thickness direction (that is, in the direction from the second to the first surface, or in the direction from the first to the second surface) of the coating layer was determined, e.g., by using SEM, EDS, or FTIR (“Fourier-transform infrared spectroscopy”). If SEM is used, images of the sample are produced by scanning the surface of the cut coating, and it is thus possible to observe the obtained image. If EDS and FTIR are used, it is possible to thereby quantitatively confirm the distribution of the hollow adhesive particles composed of polymers through elemental analysis such as Al, C, and O. The gradient between the first and second surface of the coating can be determined using the same methods. If the coating is on both sides of the porous substrate, the surface of the coating layer on one side of the substrate facing the porous substrate is referred to as a first surface and an opposite surface of the first surface of the coating on the same side of the substrate is referred to as a second surface.

In an example embodiment, the coating layer may have a gradient in which the content of the hollow adhesive particles increases from the first surface toward the second surface of the coating. The term “gradient” may mean a general trend of an increase of the content of the hollow adhesive particles to the opposite of the first surface, including a structure where the increase is continuously or linear, and a structure where the increase is non-linear and optionally has intermittent constant content (but without an intermittent decrease) of the hollow adhesive particles.

In an example embodiment, the coating layer may include an inorganic particle layer including the inorganic particles and an adhesive layer formed by the hollow adhesive particles floating on the inorganic particle layer. In an exemplary embodiment, the coating layer may include an inorganic particle sub-layer including the inorganic particles and an adhesive sub-layer formed by the hollow adhesive particles. The inorganic particle sub-layer may be formed at the first surface facing the porous substrate, and the adhesive sub-layer including the hollow adhesive particles may be formed at the second surface opposite the first surface. Within the context of the described sub-layers, the hollow adhesive particles of the adhesive sub-layer may float on the inorganic particles of the inorganic particle sub-layer. Within the meaning of the present invention, the term “floating” refers to circumstances that hollow adhesive particles, which are present in a coating composition and a slurry for its preparation and which typically, due to the hollow structure, have a lower specific gravity than the inorganic particles also present in the coating composition and the slurry for preparing it, upon forming a coating layer will arrange themselves towards the surface of the coating layer, dependent on the gravity. Accordingly, the arrangement of the respective particles follows the principle that the higher the specific gravity, the more these particles (the inorganic particles) will sink to the surface facing the porous substrate, whereas the lower the specific gravity, the more these particles (the hollow adhesive particles) will float towards the opposite surface to the outside of the porous substrate.

In an example embodiment, the coating layer may include one or more stacked layers.

In an example embodiment, the hollow adhesive particles may have a hollow rate of 5 to 97%, but are not limited thereto. It is also possible that the hollow rate is 50 to 95%. Preferably, the hollow rate is 60 to 85%, preferably the hollow rate is 65 to 80%, more preferably the hollow rate is 70 to 80%.

In an example embodiment, the hollow adhesive particles may have an average outer diameter of 10 nm to 10 μm, or of 500 nm to 2 μm, or of 500 nm to 1 μm, but are not limited thereto. The expression “average diameter” of a particle refers to the average diameter of more than one particle. The expression “diameter” of a particle refers to the diameter of a single particle.

In an example embodiment, each of the hollow adhesive particles may include a hollow core that includes an empty inner space and a shell layer including an adhesive material. In one example, the adhesive material may include an adhesive resin that has adhesive strength at room temperature or higher or at a glass transition temperature (Tg) or higher. In some implementations, the glass transition temperature (Tg) may be the temperature at which chains of a polymer start to move.

In an example embodiment, the adhesive resin may include at least one of an acryl-based resin, a fluorine-based resin, an amide-based resin, a copolymer of two or more of the acryl-based resin, the fluorine-based resin, and the amide-based resin, or a mixture of two or more of the acryl-based resin, the fluorine-based resin, and the amide-based resin, but the disclosed technology is not limited thereto.

In an example embodiment, the adhesive resin may be crosslinked.

In an example embodiment, each of the hollow adhesive particles may further include a structure material layer for maintaining a hollow structure between the hollow core and the shell layer.

In an example embodiment, an inorganic particle layer may be further included between the porous substrate and the coating layer. In some implementations, the inorganic particle layer may be distinguished from the coating layer. In one example, the inorganic particle layer may be a layer formed of inorganic particles, e.g., the inorganic particle layer is a ceramic layer. For example, the inorganic particle layer may be a layer formed of inorganic particles with pores formed between the inorganic particles, or a layer having pores between the inorganic particles bound by a binder. In some implementations, the inorganic particle layer may not include the hollow adhesive particles.

In another general aspect, a method for manufacturing a separator includes: a coating step of applying a coating composition including inorganic particles and hollow adhesive particles on one or both surfaces of a porous substrate to form a coating layer; and a drying step of drying the coating layer. In one example, a method for manufacturing a separator includes: forming a coating layer by applying a coating composition that includes inorganic particles and hollow adhesive particles onto at least one of a first surface or a second surface of a porous substrate; and drying the coating layer.

In an example embodiment, applying vibration may be further included before the drying step or with the drying.

In an example embodiment, allowing the separator on which the coating composition is applied to stand may be further included before drying after the coating step. In an example embodiment, the coating composition may be applied multiple times on either or both surfaces of the porous substrate. For this purpose, the coating process be applied to the respective surfaces, and allowing the applied coating to stand, wherein a second coating is applied after the first coating has been dried.

In an example embodiment, the coating layer may have a gradient formed by the hollow adhesive particles floating on a surface of the coating layer after the coating step and the drying step, or may have an adhesive layer formed of the hollow adhesive particles formed on the surface of the coating layer. The coating may form an adhesive sub-layer formed of the hollow adhesive particles formed on the surface. In such a sub-layer, the adhesive particles may float on the inorganic particles formed in the inorganic particle sub-layer.

In an example embodiment, the coating composition may have a solid content of 10 to 60 wt %, or of 20 to 50 wt %, or of 20 to 40 wt %, but is not limited thereto. In a further example embodiment, the coating composition may have a solid content of 30 wt %.

In an example embodiment, the coating composition may include 0.2 to 20, or 0.2 to 10, or 0.5 to 10, or 0.5 to 5, parts by weight of the hollow adhesive particles with respect to 100 parts by weight of the inorganic particles, but is not limited thereto.

In an example embodiment, the drying may be performed by hot air at 25 to 100° C., or at 25 to 80° C., or at 30 to 60° C. Usually, the drying is performed until there is no more detectable weight loss.

In another general aspect, a secondary battery includes: the separator of the example embodiment.

In still another general aspect, a method for manufacturing a secondary battery includes: placing the separator according to an example embodiment between a positive electrode and a negative electrode and applying heat, pressure, or heat with pressure to integrate the separator and an electrode.

Other features and aspects will be apparent from the following detailed description, the drawings, and the claims.

### BRIEF DESCRIPTION OF THE DRAWINGS

FIG. 1 illustrates an example of a hollow adhesive particle 10 including a hollow core 11 having an empty inner space and a shell layer 12 of an adhesive material.

FIG. 2 illustrates an example of a hollow adhesive particle 10 including a hollow core 11 having an empty inner space, a structure material layer 13 for forming and maintaining a hollow structure, and a shell layer 12 formed of an adhesive material.

FIG. 3 illustrates an example method for manufacturing a separator.

FIG. 4 illustrates a method for evaluating stacking adhesiveness.

### DETAILED DESCRIPTION

Section headings are used in the present document only for ease of understanding and do not limit scope of the embodiments to the section in which they are described.

In some embodiments of the disclosed technology, units are based on weights, and as an example, a unit of % or ratio may include a wt % or a weight ratio, and wt % refers to wt % of any one component in a total composition.

In some embodiments of the disclosed technology, a numerical range may include all values within the range including the lower limit and the upper limit, increments logically derived in a form and span of a defined range, all double limited values, and all possible combinations of the upper limit and the lower limit in the numerical range defined in different forms. In some embodiments of the disclosed technology, values that are outside a numerical range due to experimental error or rounding off of a value are also included in the defined numerical range.

The term “comprise” in the present specification is an open-ended description having a meaning equivalent to the term such as “is/are provided”, “contain”, “have”, or “is/are characterized”, and does not exclude elements, materials, or processes which are not further listed.

In some embodiments, when a layer or member is positioned “on” another layer or member, the layer or member may be in contact with another layer or member, or another layer or member may exist between two layers or two members.

In secondary batteries, a separator is a permeable membrane placed between the anode and the cathode of a battery to transport ionic charge carriers while separating the anode and the cathode. A secondary battery with an electrode-separator combination structure may have a weak binding force between the electrode (e.g., the anode or cathode) and the separator. In such a case, a defect may occur where the electrode and the separator are separated. Thus, it may be difficult to increase the size and capacity of the secondary battery.

In some implementations, to address these and other issues by providing a separator with an improved adhesive strength, an adhesive material such as a polymer resin can be coated on the surface in contact with the electrode. Such a separator may be manufactured by forming each of an inorganic particle layer and a polymer resin layer for improving heat resistance on a porous substrate, or coating the porous substrate with a one-component coating solution in which a polymer resin and inorganic particles are mixed.

However, in the case of the separator in which the polymer resin layer is separately formed on the inorganic particle layer, each layer may be separately manufactured. Such manufacturing process may cause a long manufacturing time, and a low process efficiency or poor productivity.

In addition, in the case of a separator in which the polymer resin particles and the inorganic particles are mixed to form a coating layer, the manufacturing process becomes simple, but the adhesion of the separator may not be sufficiently strong since the inorganic particles and the polymer resin are mixed on a surface in contact with an electrode.

In some implementations, the adhesion of the separator may be improved by adding a large amount of polymer resin. However, when charging and discharging a secondary battery, the polymer resin may dissolve in the electrolyte and elute, or the polymer resin may swell due to the electrolyte and block the pores inside the separator, which may reduce battery performance.

The disclosed technology can address issues discussed above by providing a separator that has high adhesion even with a small amount of adhesive material, acts as a buffer against swelling, suppresses swelling, and has low electrolyte elution.

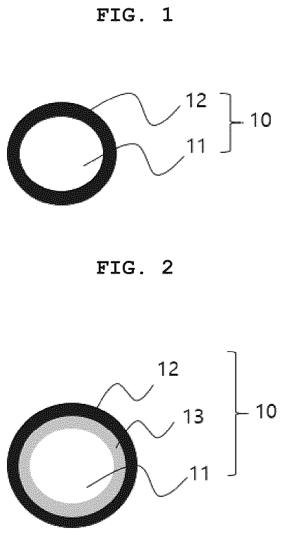

In some embodiments, a “hollow adhesive particle” refers to a particle that includes an empty space inside the particle and has adhesiveness. Specifically, as shown in FIGS. 1 and 2, a hollow adhesive particle may include a hollow core 11 having an empty inner space and a shell layer 12 including an adhesive material formed outside the hollow core 11. The shell layer 12 may be formed of one or more layers. In some implementations, as shown in FIG. 2, a structure material layer 13 for forming and maintaining a hollow structure may be further included between the hollow core 11 and the shell layer 12 such that the shell layer 12 is formed outside the structural material layer 13. FIGS. 1 and 2 merely illustrate some examples of the hollow adhesive particles based on an example embodiment of the disclosed technology, and thus the disclosed technology is not limited thereto.

In addition, the term “adhesive particles” can be used to indicate particles that can increase peel strength and/or skid resistance, when the separator comes into contact with or pressed against a negative electrode or positive electrode of a battery.

In some cases, when an electrode and a separator are stacked, a surface in contact with the electrode is coated with an adhesive material to provide a separator having an improved adhesive strength. However, a separator having a coating layer formed by mixing an adhesive material and inorganic particles has poor adhesive strength compared to the content of the adhesive material, since the inorganic particles and the adhesive material are mixed on the surface in contact with the electrode. In order to address this issue, a large amount of the adhesive material may be added to the coating layer, but in this case, when it is applied to a secondary battery, battery performance may be degraded by the adhesive material.

A separator implemented based on some embodiments of the disclosed technology may include: a porous substrate; and a coating layer placed on one or both surfaces of the porous substrate and includes inorganic particles and hollow adhesive particles.

In an example embodiment of the disclosed technology, since the hollow adhesive particles have a structure having an empty inner space, they have a lower specific gravity than the inorganic particles and may float on the surface. Accordingly, the coating layer is formed by applying the adhesive composition and the inorganic particles in a mixed state simultaneously without the need for a separate process of applying an adhesive composition for forming an electrode adhesive layer to form a coating layer, and thus, electrode adhesiveness may be imparted by hollow adhesive particles naturally floating on a surface layer.

Since the hollow adhesive particles have a lower specific gravity than the inorganic particles due to their hollow structure, the hollow adhesive particles may be easily guided to the surface of the coating layer when forming the coating layer, by including the hollow adhesive particles in the coating layer as discussed above. Accordingly, since there is no need to form a separate adhesive layer, even a small amount of an adhesive material, that is, a small amount of the hollow adhesive particles may provide a sufficient adhesive strength to an electrode.

In addition, when swelling occurs by an electrolyte and the like, a separator based on some embodiments of the disclosed technology may provide an effect of internally accommodating swelling to prevent occurrence of external swelling in the coating layer. In addition, a secondary battery including the separator based on an example embodiment of the disclosed technology may provide a sufficient adhesive strength between an electrode and a separator during battery assembly to improve cell assembly processability, and may prevent separation between the electrode and the separator during charge/discharge, thereby preventing various problems such as a resistance increase or a cycle life reduction by separation between the electrode and the separator. In addition, battery swelling may be prevented.

That is, when there is a coating layer including the hollow adhesive particles, a new separator based on some embodiments can internally accommodate swelling caused by an electrolyte and can prevent external swelling while providing an excellent adhesion between the separator and the electrode.

In addition, a separator based on some embodiments can internally accommodate swelling caused by an electrolyte to suppress external swelling and can prevent elution of an adhesive into the electrolyte by the electrolyte.

In addition, since the separator suppresses swelling caused by an electrolyte to minimize the loss of the adhesive strength to an electrode, that is, prevent the loss of the adhesive strength caused by swelling, a separator based on some embodiments can maintain alignment of an electrode module even when many electrodes and separators are stacked. In some embodiments, a battery may include the separator discussed above. In addition, the performance of electrodes may be improved by suppressing swelling and elution.

Specifically, the separator may include hollow adhesive particles made of a polymer as an adhesive that fixes inorganic particles to an electrode. In the coating layer, the inorganic particles are connected to each other to form pores by the inorganic particles.

The separator may suppress the swelling, increase the electrode adhesive strength, maintain the alignment, and prevent the adhesive strength loss, as compared to a separator made of inorganic particles and an adhesive of a thermoplastic resin, for example, a thermoplastic resin such as polyacrylate and polyamide.

In addition, the hollow adhesive particles having a lower specific gravity or density may be placed to be concentrated on a surface in contact with an electrode due to a specific gravity difference between the hollow adhesive particles and the inorganic particles in the coating layer, and thus, adhesive strength on the surface of the coating layer in contact with the electrode may be improved even when the content of adhesive particles showing adhesiveness is minimized. In addition, since the content of the adhesive material may be minimized, a degraded battery performance problem by the adhesive material may be prevented, of course.

In the separator based on an example embodiment of the disclosed technology, when a surface facing the porous substrate is referred to as a first surface and an opposite surface of the first surface is referred to as a second surface, the second surface may have a higher content of the hollow adhesive particles than the first surface.

In addition, the coating layer may have a gradient in which the content of the hollow adhesive particles is increased from the first surface toward the second surface.

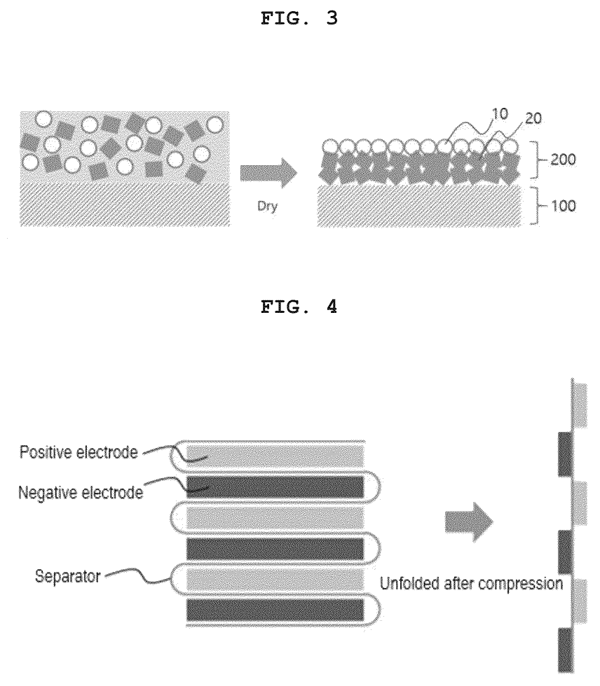

In addition, the coating layer may include an inorganic particle layer including the inorganic particles and an adhesive layer formed by the hollow adhesive particles floating on the inorganic particle layer. That is, as shown in FIG. 3, the hollow adhesive particles may float to form a separate layer from the layer formed of the inorganic particles.

In an embodiment of the disclosed technology, the separator may include a single coating layer. In another embodiment of the disclosed technology, a plurality of coating layers may be stacked, and in this case, the content of the hollow adhesive particles to the inorganic particles for each layer varies by a plurality of stacks, and by increasing the content of the hollow adhesive particles on the surface in contact with an electrode, the electrode adhesive strength may be further improved.

That is, when the coating layer has a single layer structure, due to a specific gravity difference between the hollow adhesive particles and the inorganic particles, in a process of coating the surface of the porous substrate with a slurry in which the hollow adhesive particles and the inorganic particles are mixed and drying the slurry, the hollow adhesive particles may naturally float on the surface to have a concentration gradient or form a separate adhesive layer. In another implementation, after coating the slurry, it is maintained for a certain period of time so that the hollow adhesive particles may sufficiently float on the surface and the inorganic particles may settle toward the porous substrate, and at this time, by adjusting the certain period of time, the concentration gradient of the hollow adhesive particles may be intentionally formed. That is, when a surface of the coating layer facing the porous substrate is referred to as a first surface and the opposite surface of the first surface is referred to as a second surface, the gradient may be adjusted so that the concentration of the hollow adhesive particles continuously increases from the first surface toward the second surface, or more hollow adhesive particles are distributed on the second surface by adjusting the maintenance time. Otherwise, the hollow adhesive particles may float on the second surface to form the adhesive layer.

In addition, the coating layer may have a multilayer structure in which at least one or more layers are stacked.

As an example, it may be a multilayer structure which is formed of a plurality of layers having different contents of the hollow adhesive particles, by changing the contents of the inorganic particles and the hollow adhesive particles. Specifically, the coating layer may have a structure that can be divided into n layers (n is a natural number≤2) having different concentrations of the hollow adhesive particles. Specifically, n may be 2 to 5.

The coating layer may include a first coating layer having a first content of the hollow adhesive particles which includes a first surface in contact with the porous substrate and a second surface which is the opposite surface of the first surface, a second coating layer having a second content of the hollow adhesive particles which includes a third surface in contact with the second surface and a fourth surface which is the opposite surface of the third surface, and an nth coating layer having an nth content of the hollow adhesive particles. For example, when the coating layer is divided into two layers, it may be divided into a first coating layer having a first content of the hollow adhesive particles and a second coating layer having a second content of the hollow adhesive particles. In addition, each coating layer may be formed by being directly in contact with each other. It is also possible that the coating layers have different coating compositions: For example, the coating compositions can differ in terms of the inorganic particles and/or hollow adhesive particles used (that is, the respective materials inorganic particles and/or hollow adhesive particles are different); and/or regarding the respective amount of the inorganic particles and/or hollow adhesive particles used.

The respective coating layers (first, second, nth) that are included in the coating layer (that is, which form the coating layer) can be delimited from each other as each surface of the layer has a different concentration or gradient of the hollow adhesive particles, by way of its preparation. For example, the first surface of the first layer has a less concentration (amount) of hollow adhesive particles than the second surface of the first layer. The third surface of the second layer (which is adjacent to the second surface of the first layer) has a less concentration (amount) of hollow adhesive particles than the second surface of the first layer. Thus, the first coating layer can be delimited from the second coating layer. This logic applies to all n coating layers that may be present.

In some embodiments of the disclosed technology, since the separator has a porous structure, it has pores therein and may have porosity. The size and the porosity of pores formed in the separator may be appropriately adjusted depending on the porosity of the porous and the thickness of the coating layer. As an example, the average size of the pores formed in the separator, that is, the average diameter of the pores, may be 0.001 to 10 μm, and the porosity may be 10 to 70%.

The separator based on an example embodiment of the disclosed technology may have a gas permeability of 500 sec/100 cc or less, 400 sec/100 cc or less, 300 sec/100 cc or less, 200 sec/100 cc or less, or 100 sec/100 cc or less. The gas permeability is measured in accordance with the standard of ASTM D 726, using a densometer available from Toyoseiki.

In addition, a Gurley permeability change amount ΔG according to the following equation may be 50 sec/100 cc or less, 45 sec/100 cc or less, 40 sec/100 cc or less, 35 sec/100 cc or less, or 30 sec/100 cc or less:

$$Δ G = G 1 - G 2$$

Here, G1 is a Gurley permeability of a separator in which a coating layer is formed on both surfaces of a porous substrate, and G2 is a Gurley permeability of the porous substrate itself.

The Gurley permeability is measured in accordance with the standard of ASTM D 726, using a densometer available from Toyoseiki, and its unit is sec/100 cc.

In addition, a heat shrinkage rate at 150° C. may be 8% or less, 7% or less, 6% or less, 5% or less, 4% or less, 3% or less, 2% or less, or 1% or less. In addition, a heat shrinkage rate at 170° C. may be 8% or less, 7% or less, 6% or less, 5% or less, 4% or less, 3% or less, or 2% or less.

In addition, a thickness change rate when charging and discharging a battery 100 times after assembling the battery may be 5% or less, 4% or less, 3% or less, 2% or less, or 1% or less. In addition, when the separator and the electrode are compressed at a temperature of 60° C. or higher and a pressure of 1 kgf/cm² or more for 10 seconds or more, and then peeled off at 180° using UTM equipment available from INSTRTON according to ASTM D 903, an adhesive strength between the separator and the electrode may be 0.5 gf/15 mm or more, 1 gf/15 mm or more, for example, 0.5 to 4 gf/15 mm.

In addition, electrode adhesive strength may be excellent in the electrode adhesive strength evaluation described later. Specifically, as shown in FIG. 4, when the separator was stacked with 3 sheets of positive electrodes and 3 sheets of negative electrodes having a size of 4×6 cm to be crossed, adhered with 1 kgf/cm² for 10 seconds under a temperature atmosphere of 60° C., and then unfolded to evaluate the number of attached electrodes, all 6 sheets maintains adhesion without being separated.

### [Porous Substrate]

As an example, the porous substrate of the separator is not limited as long as it is conventionally used as a substrate of the separator. Specifically, it may be a film, a sheet, non-woven fabric, and textile of a polymer material. Specifically, the porous substrate may include a porous substrate made of a polyolefin-based resin. The polyolefin-based resin may be one or more selected from the group consisting of high-density polyethylene, low-density polyethylene, linear low-density polyethylene, ultrahigh molecular polyethylene, polypropylene, and copolymers thereof, but is not limited thereto.

The thickness of the porous substrate is not particularly limited, but may be in a range of 1 to 100 μm, 5 to 60 μm, 5 to 40 μm, 5 to 20 μm, or 5 to 10 μm. The porous substrate may be in the form of a porous film.

The size of the pores formed in the porous substrate is not limited as long as lithium ions move well in the size, but it may be advantageous that the average diameter is 0.01 to 20 μm, 0.05 to 5 μm, or 0.05 to 1 μm, for smooth movement of lithium ions and impregnation of the electrolyte solution. In addition, though it is not particularly limited, porosity may be 5 to 95% or 30 to 60%.

The porosity may be calculated by the following equation from the ratio between the weight of a resin having the same volume and the weight of a separator (Mg), after cutting a sample into a rectangle of A cm×B cm (thickness: T μm), and measuring the mass: Porosity (%)=100×{1−M×10000/(A×B×T×ρ)} wherein ρ (g/cm³) is a density of resin.

### [Coating Layer]

As an example, the coating layer is formed on one or both surfaces of the porous substrate, and may be a layer of a porous structure in which the inorganic particles and the hollow adhesive particles are connected to each other to form pores. Otherwise, it may have a stacked structure in which an inorganic particle layer in which the inorganic particles are connected to each other to form pores and an adhesive layer formed by the hollow adhesive particles floating on the inorganic particle layer are formed. The coating layer may be formed by being directly in contact with the porous substrate. Otherwise, another layer which is usually used in a separator, specifically, an inorganic particle layer having pores formed between the inorganic particles, may be separately further provided between the porous substrate and the coating layer, but the disclosed technology is not limited thereto.

Since the hollow adhesive particles are concentrated on the surface in contact with an electrode, as described above, the coating layer may solve a problem of the conventional separator.

The thickness of the coating layer is not particularly limited, for example, the thickness of the coating layer formed on one surface of the porous substrate may be 0.1 μm or more, 0.5 μm or more, 1 μm or more, 1.5 μm or more, 2 μm or more, 3 μm or more, or 5 μm or more, and for example, 0.1 to 10 μm, 0.2 to 5 μm, or 0.2 to 3 μm, but is not limited thereto. In addition, the coating layer may include an adhesive layer formed by the floating hollow adhesive particles, and the thickness of the adhesive layer is not limited, but may be 0.01 to 20 μm. The thickness of the adhesive layer may be adjusted by adjusting the content of the hollow adhesive particles, but is not limited thereto.

A thickness ratio between the porous substrate and the coating layer of the separator is not limited. In one example, the thickness ratio between the porous substrate and the coating layer of the separator may be 1:0.01 to 1, or 1:0.05 to 0.5. Within the range, excellent battery stability, swelling suppression, battery performance improvement, and excellent adhesive strength to an electrode may be secured, but the disclosed technology is not limited thereto. As an example, the coating layer may be formed on 90% or more or 95% or more of the entire area of each surface, or 100% of the entire area of each surface of the porous substrate except the case in which fine defects occur, for each surface of the porous substrate.

The coating layer may further include other commonly known additives in addition to the inorganic particles and the hollow adhesive particles described above. For example, the additive may be a dispersing agent, a lubricant, a defoaming agent, a thickening agent, or the like, and the content may be approximately a commonly used content.

In addition, the coating layer may further include a conventional binder, not the hollow adhesive particles, as an additive for fixing the particles of the inorganic particle layer, but its amount may be significantly smaller than a conventionally used amount. The conventional binder is not particularly limited, but, for example, may include any one or a mixture of two or more selected from acryl-based polymers, styrene-based polymers, vinylalcohol-based polymers, vinylpyrrolidone-based polymers, fluorine-based polymers, and the like.

For example, it may be any one, a mixture of two or more, or a copolymer thereof selected from polyacrylamide, poly(meth)acrylate, acrylic acid-methacrylic acid copolymer, polystyrene, polyvinylalcohol, polyvinylacetate, polyvinylacetate-polyvinylalcohol copolymer, polyvinylpyrrolidone, polyfluorovinylidene, polytetrafluoroethylene, polyhexafluoropropylene, hexafluoropropylene, polyvinylidenefluoride-hexafluoropropylene, polychlorotrifluoroethylene, and the like, but is not limited thereto.

The binder and the additive may be further included appropriately at minimum amounts, but as a non-limiting example, 0.1 to 5 parts by weight of the binder and 0.1 to 3 parts by weight of the additive may be included with respect to 100 parts by weight of the inorganic particles. This is only an example, and the disclosed technology is not limited thereto.

The inorganic particles included in the coating layer may be, for example, any one or two or more selected from metal oxides, metal nitrides, metal carbides, metal carbonates, metal hydroxides, metal carbonitrides, and the like. For example, they may be one or more selected from boehmite, Ga₂O₃, SiC, SiC₂, Quartz, NiSi, Ag, Au, Cu, Ag—Ni, ZnS, Al₂O₃, TiO₂, CeO₂, MgO, NiO, Y₂O₃, CaO, SrTiO₃, SnO₂, ZnO, ZrO₂, and the like, but are not necessarily limited thereto, unless they are electrochemically unstable to have a significant influence on battery performance.

The shape of the inorganic particles is not particularly limited as long as the purpose of the porous substrate to improve durability and heat resistance is achieved. Specifically, the inorganic particles may have any one or more shapes selected from the group consisting of spherical, prismatic, and amorphous shapes.

In addition, the size of the inorganic particles is not limited as long as the purpose described above is achieved, and specifically, the size, that is, the average diameter of the inorganic particles may be 0.001 to 100 μm, specifically 0.01 to 50 μm, and more specifically 0.01 to 10 μm. Within the range, the separator may have the porosity in the range described above, but is not necessarily limited thereto.

The hollow adhesive particles used in the coating layer may be hollow organic particles or polymer particles, and as shown in FIGS. 1 and 2, they have a hollow formed inside to have lower density and buoyancy than the inorganic particles. The hollow rate of the hollow adhesive particles is not particularly limited, as long as the purpose described above, that is, forming density lower than that of the inorganic particles is achieved. As an example, the hollow rate of the hollow adhesive particles may be 5 to 97% or 50 to 95%, but is not limited thereto. The hollow rate may be calculated by the following equation from the outer diameter and the inner diameter of the hollow adhesive particles. The outer diameter and the inner diameter refer to an average particle diameter and may be measured using SEM and the like. Hollow rate (%)=inner diameter/outer diameter×100, wherein the outer diameter refers to an average particle diameter, that is, an average outer diameter of the hollow adhesive particles, and the inner diameter is calculated as a value obtained by subtracting the thickness of the shell layer from the average particle diameter, after measuring the thickness of the shell layer using SEM, TEM, and the like. In addition, in the case of hollow adhesive particles having a non-uniform hollow shape of the hollow adhesive particles, the hollow rate may be calculated by a correlation between density measured using powder density measurement and the like (apparent density) and theoretical density. In this case, the hollow rate (%) may be calculated by (1−apparent density/theoretical density)×100. Further, in the present disclosure, the thickness e.g., of a layer such as the shell layer or of a substrate such as the porous substrate, or of a film, can be measured as follows:

The thickness of a shell layer or of a core, or the diameter of a hollow particle, can be measured by applying electron microscopic observation, such as SEM or TEM, preferably SEM. The thickness of the porous film can be measured by applying a Mitutoyo's thickness meter according to the manufacturer's instructions.

The hollow adhesive particles include the hollow core 11 having an empty inner space and the shell layer 12 formed of an adhesive material, as shown in FIG. 1, and the shell layer may be formed of at least one or more layers. In addition, as shown in FIG. 2, the structure material layer 13 for the hollow core forming and maintaining a hollow structure may be further included between the hollow core 11 and the shell layer 12.

As the shell layer of the hollow adhesive particles, a material having adhesiveness to the porous substrate and the electrode may be used, and the material is not particularly limited as long as it is conventionally used as an adhesive material and has adhesive strength. As an example, the adhesive material may be an adhesive resin having adhesive strength at room temperature or a glass transition temperature (Tg) or higher. The adhesive resin may include a thermoplastic polymer, and for example, may include an acryl-based resin, a fluorine-based resin, an amide-based resin, and a copolymer thereof or a mixture thereof, but is not limited thereto. As an example, the shell layer of the hollow adhesive particles may be a shell layer in which the adhesive resin is crosslinked.

In addition, the structure material layer may be formed of a resin which is the same as or different from the shell layer, and may be used without limitation as long as it is a material for maintaining the empty inner space of the hollow core. In addition, it may also be formed of a material having adhesiveness or no adhesiveness. Specifically, for example, it may be selected from SiO₂, Al₂O₃, ZnO, TiO₂, SnO₂, carbon, polystyrene, polyacrylate, PVDF, and the like, but is not limited thereto.

The size of the hollow adhesive particles is not limited as long as they achieve the purpose described above, and the size, that is, the average outer diameter of the hollow adhesive particles, may be 10 nm to 10 μm, 50 nm to 5 μm, 0.1 to 5 μm, or 0.2 to 2 μm, but is not necessarily limited thereto.

As described above, the hollow adhesive particles are not particularly limited as long as they form a hollow. As an example, they may be prepared by polymerizing acrylate, acrylic acid, and a polyfunctional acryl-based crosslinking agent. Herein, a polar monomer such as acrylic acid may be included, which may not only induce adhesion to the inorganic particles of the coating layer but also improve adhesive strength to the active material or the metal layer of an electrode, and thus, may be preferred, but is not limited thereto.

The hollow adhesive particles may be prepared by various preparation methods, and for example, may be prepared by a method of Korean Patent Laid-Open Publication No. 2020-0138213 (publication date: Dec. 9, 2020, Zeon Corporation, Japan) and the like, but is not limited thereto. The hollow adhesive particles may have a hollow adhesive particle shape having a crosslinked shell layer, for example, by increasing a crosslinking ratio of a crosslinked monomer in the shell layer so that the particles do not collapse, in order to maintain an internal hollow shape.

The shell layer may be a single layer, and may have a plurality of layers, but is not particularly limited. Therefore, the coating layer may include any one of single-structured hollow adhesive particles and double-structured hollow adhesive particles, and unlike this, may both include the single-structured hollow adhesive particles and double-structured hollow adhesive particles. In addition, it may include all of the hollow adhesive particles illustrated in FIGS. 1 and 2.

The coating layer may include more inorganic particles considering the content of the hollow adhesive particles. The content of the hollow adhesive particles may be a small amount to express adhesiveness, and as an example, 0.1 parts by weight or more, 0.2 parts by weight or more, 0.3 parts by weight or more, 0.4 parts by weight or more, 0.5 parts by weight or more, 0.6 parts by weight or more, 0.7 parts by weight or more, 0.8 parts by weight or more, 0.9 parts by weight or more, 1.0 part by weight or more and 20 parts by weight or less, 19 parts by weight or less, 18 parts by weight or less, 17 parts by weight or less, 16 parts by weight or less, or 16 parts by weight of the hollow adhesive particles may be used with respect to 100 parts by weight of the inorganic particles, and a range therebetween may be used. For example, 0.1 to 20 parts by weight, 0.2 to 20 parts by weight, 1 to 20 parts by weight, 1 to 15 parts by weight, 1 to 10 parts by weight, 1 to 8 parts by weight, or 1 to 5 parts by weight may be included, and though it is not limited thereto, sufficient electrode adhesive strength may be exerted in the range. In addition, if necessary, 0.1 to 5 parts by weight of a non-hollow polymer binder and 0.1 to 5 parts by weight of an additive may be further included with respect to 100 parts by weight of the inorganic particles, but the disclosed technology is not limited thereto.

### [Method for Manufacturing Separator]

Hereinafter, a method for manufacturing a separator will be described in detail.

In some embodiments of the disclosed technology, a method for manufacturing a separator includes: a coating step of applying a coating composition including inorganic particles and hollow adhesive particles on one or both surfaces of a porous substrate to form a coating layer; and a drying step of drying the coating layer.

As an example, as shown in FIG. 3, a coating composition including inorganic particles 20 and hollow adhesive particles 10 is applied on one surface of a porous substrate 100, and then dried, so that the content of the hollow adhesive particles is higher on the surface of a coating layer 200, that is, a surface which is not in contact with the porous substrate. Otherwise, the hollow adhesive particles may be substantially guided to the surface to form an adhesive layer.

As an example, when a surface facing the porous substrate is referred to as a first surface and an opposite surface of the first surface is referred to as a second surface, the second surface may have a higher content of the hollow adhesive particles than the first surface. As an example, the coating layer may be manufactured so as to have a gradient in which

the content of the hollow adhesive particles is increased from the first surface toward the second surface. Otherwise, the coating layer may include an inorganic particle layer including the inorganic particles and an adhesive layer formed by the hollow adhesive particles floating on the inorganic particle layer.

As an example, in order to intentionally induce a gradient by a specific gravity difference between the hollow adhesive particles and the inorganic particles or formation of a separate adhesive layer, before the drying step, it may be allowed to stand for a certain period of time, vibrated, or allowed to stand and vibrated simultaneously or continuously, respectively, and then dried. That is, after the coating composition is applied, it may be allowed to stand for a certain period of time and then dried. Otherwise, after the coating composition is applied, it may be allowed to stand for a certain period of time, vibrated, and then dried. Otherwise, after the coating composition is applied, it may be vibrated while being allowed to stand for a certain period of time, and then dried. Otherwise, after the coating composition is applied, it may be allowed to stand for a certain period of time and then dried with vibration. Otherwise, after the coating composition is applied, it may be vibrated and then dried. Otherwise, after the coating composition is applied, it may be dried with vibration. As an example embodiment, a time for standing for a certain period of time may be adjusted to adjust the gradient of the hollow adhesive particles, or form an adhesive layer formed by the floating hollow adhesive particles.

As an example, when the coating layer is formed on both surfaces of the porous substrate, the coating layer may be formed on one surface and then formed on the other surface.

In an embodiment, coating may be performed on both surfaces simultaneously. In another embodiment, the composition is applied individually in terms of guiding the hollow adhesive particles to the surface.

As described above, the hollow adhesive particles move to an air surface (opposite surface of the surface in contact with the porous substrate) by the specific gravity difference and dried, whereby many hollow adhesive particles having adhesive properties are present on the surface, and adhesive strength to an electrode may be expressed even when a low content of the hollow adhesive particles is used.

The hollow adhesive particles may adjust a crosslinking degree to adjust strength, and in particular, adjust compression strength, and induce an increase in heat resistance.

The method for manufacturing a separator as such may easily produce a separator having excellent adhesive strength to an electrode only by forming the coating layer including the hollow adhesive particles on the porous substrate.

In addition, as an example, the coating layer may further include a non-hollow organic binder as a conventional organic binder described above, but the content may be significantly decreased by the use of the hollow adhesive particles.

In the manufacturing method, since the porous substrate, the inorganic particles, the hollow adhesive particles, and the manufactured separator are as described above, the detailed description thereof will be omitted, and each step will be further described.

The coating composition may be in a slurry form in which the inorganic particles and the hollow adhesive particles are dispersed in a solvent. Besides, the coating composition may further include a non-hollow polymer binder, if necessary, and also, may further include an additive commonly used in the art.

The solvent is not particularly limited as long as the inorganic particles and the hollow adhesive particles which are solids may be dispersed therein. As an example, water, lower alcohols such as ethanol, methanol, and propanol, solvents such as dimethylformamide, acetone, tetrahydrofuran, diethylether, methylene chloride, N-ethyl-2-pyrrolidone, hexane, and cyclohexane, or a mixture thereof may be used, but the disclosed technology is not necessarily limited thereto.

The solid content in the coating composition in a slurry form may be appropriately adjusted so that the composition is easily applied and may induce a layer separation phenomenon by a density difference between the inorganic particles and the hollow adhesive particles described above during drying. Specifically, the solid content in the coating composition may be 10 to 60 wt % or 20 to 50 wt %, but is not limited thereto. The solid includes the inorganic particles and the hollow adhesive particles, and also, if necessary, may further include a non-hollow polymer binder. As an example, the solid content may include 0.1 to 20 parts by weight, 0.1 to 15 parts by weight, 0.1 to 10 parts by weight, 0.1 to 8 parts by weight, 0.1 to 5 parts by weight, or 0.1 to 2 parts by weight of the hollow adhesive particles with respect to 100 parts by weight of the inorganic particles. In addition, if necessary, 0.1 to 5 parts by weight of a non-hollow polymer binder and 0.1 to 5 parts by weight of an additive may be further included with respect to 100 parts by weight of the inorganic particles, but the disclosed technology is not limited thereto.

In addition, the coating composition may further include an additive within a range which does not significantly degrade applicability or battery performance. Specifically, for example, the additive may be a dispersing agent, a lubricant, a deforming agent, a thickener, or the like, and is not limited thereto, and since it is as described above, additional description will be omitted.

A coating method of coating one or both surfaces of the porous substrate with the coating composition is not limited, and specifically, for example, may be a common coating method such as bar coating, dip coating, flow coating, knife coating, roll coating, gravure coating, and spray coating.

In the drying step, a dying means is not particularly limited as long as 90% or more of the solvent may be removed. A drying temperature may be changed depending on the solvent, and for example, may be 20 to 200° C., and is not limited unless the surface structure is changed by rapid evaporation of the solvent or the hollow adhesive particles are melted and collapse. As a specific example, drying may be performed by hot air at 25° C. to 100° C. and a drying time is not limited, but, for example, 5 seconds to 300 seconds. In addition, drying may be performed by a method of infrared, near-infrared, heating roll, and a hybrid form thereof. Within the range, the hollow adhesive particles float well, so that more hollow adhesive particles may be present in an upper area, an adhesive layer, or an nth coating layer.

In an example embodiment, the drying step may impart vibration or an artificial standing time before drying, or the concentration gradient of the hollow adhesive particles may be imparted by the mixing means.

When the vibration is applied, the hollow adhesive particles may float more easily by a specific gravity difference between the inorganic particles and the hollow adhesive particles. A vibration method is not particularly limited as long as it may apply vibration to the coating composition. Vibration may be directly applied to the coating composition by applying energy, for example, by ultrasonic waves and the like. Unlike this, vibration may be applied to the coating composition by applying physical vibration by a motor and the like.

In an example embodiment, a standing step may be further included before the drying step so that the gradient of the hollow adhesive particles is sufficiently formed. Specifically, the coating composition is applied on a porous substrate, and allowed to stand for 30 seconds to 1 hour, so that the hollow adhesive particles sufficiently float on the surface of the coating layer. A standing temperature may be 0 to 50° C., preferably room temperature (25±5° C.), but is not limited thereto.

### [Secondary Battery]

Hereinafter, a secondary battery will be described in detail.

In some embodiments of the disclosed technology, the secondary battery includes the separator described above, and specifically, may have a structure in which the separator described above is interposed and combined between two electrodes, which are a negative electrode and a positive electrode.

Specifically, the positive electrode and the negative electrode are not limited as long as they are common materials used as the positive electrode and the negative electrode of a secondary battery.

The secondary battery including the separator described above has improved adhesive strength between the electrode and the separator, thereby preventing separation between the electrode and the separator during charge and discharge. Thus, various problems such as a resistance increase or a reduced cycle life by separation between the electrode and the separator may be solved, and a higher capacity and a larger size are allowed, and thus, industrial availability may be substantially very high. In addition, adhesive strength is high, but less adhesive material is included, and thus, a battery performance degradation problem by the adhesive material may be prevented.

Hereinafter, a method for manufacturing a secondary battery will be described in detail.

In some embodiments of the disclosed technology, the method for manufacturing a secondary battery is a method for manufacturing the secondary battery described above, and includes placing the separator described above between two electrodes, and applying heat, pressure, or heat with pressure to adhere an electrode on the separator. The method for manufacturing a secondary battery as such may simply produce a secondary battery having very high durability.

Adhesion may be performed by applying heat, pressure, or heat with pressure, but specifically, may be heat fusion which applies both heat and pressure. When the adhesion as such is performed, hollow adhesive particles may be broken. Thus, higher adhesive strength may be rather provided.

Specifically, adhesion may be performed by applying heat to the temperature at or higher than the glass transition temperature (Tg) of the hollow adhesive particles, more specifically, Tg to 1.2 Tg of the hollow adhesive particles, but is not limited thereto. However, the hollow adhesive particles may be broken while maintaining high adhesive strength within the range.

Hereinafter, some embodiments of the disclosed technology will be described in more detail with reference to the examples and the comparative examples. However, the following examples and comparative examples are presented illustrative purposes, and do not limit the disclosed technology in any way.

Hereinafter, the physical properties were measured as follows:

### 1) Adhesiveness to Electrode

A manufactured separator was placed between a positive electrode and a negative electrode and adhered at 60° C., 1 kgf/cm², for 10 seconds, and adhesive strength to the electrode was evaluated.

The positive electrode and the negative electrode used in the evaluation were manufactured as follows:

Manufacture of positive electrode: 92 wt % of a lithium cobalt composite oxide (LiCoO₂) as a positive electrode active material, 4 wt % of carbon black as a conductive material, and 4 wt % of polyvinylidene fluoride (PVDF) as a binder were added to N-methyl-2-pyrrolidone (NMP) as a solvent to prepare a positive electrode mixture slurry. The prepared slurry was applied on an aluminum (Al) thin film having a thickness of 30 μm, dried at a temperature of 120° C., and roll-pressed to manufacture a positive electrode having a thickness of 140 μm.

Manufacture of negative electrode: 96 wt % of graphite carbon, 3 wt % of PVDF as a binder, and 1 wt % of carbon black as a conductive material were added to NMP as a solvent to prepare a negative electrode mixture slurry. The prepared slurry was applied on a copper (Cu) thin film having a thickness of 20 μm, dried at 120° C., and roll-pressed to manufacture a negative electrode having a thickness of 150 μm.

Electrode adhesive strength was measured by peeling off at 180° using UTM equipment available from INSTRON in accordance with ASTM D 903. The unit of adhesive strength is gf/15 mm.

### 2) Stacking Adhesiveness

The electrode used in the adhesiveness evaluation was cut into a size of 4 cm wide and 6 cm long, and 3 sheets of cut positive electrodes and 3 sheets of cut negative electrodes were stacked by being crossed on the surface of the separator as shown in FIG. 4, adhered for 10 seconds at 1 kgf/cm² under a temperature atmosphere of 60° C., and unfold, thereby evaluating the number of adhered electrodes.

### 3) Gas Permeability

The gas permeability was measured using a Gurley type densometer available from Toyoseiki in accordance with JIS P8117. The measured value was corrected with a thickness value and used after being converted into a value having no difference depending on the thickness.

### 4) Gurley Permeability Change Amount

The Gurley permeability change amount ΔG was calculated as follows:

$$Δ G = G 1 - G 2$$

wherein G1 is a Gurley permeability of a separator in which a coating layer is formed on both surfaces of a porous substrate, and G2 is a Gurley permeability of the porous substrate itself. The Gurley permeability is measured in accordance with the standard of ASTM D 726, using a densometer available from Toyoseiki, and its unit is sec/100 cc.

### 5) Heat Shrinkage Rate

A separator of 10 cm×10 cm was allowed to stand at 130° C., 150° C., and 170°, respectively, for 1 hour, an area reduction rate was measured, and a heat shrinkage rate was calculated by the following equation:

$$Heat shrinkage rate ( \% ) = ( ( length before heating - length after heating ) / length before heating ) \times 100.$$

### 6) Battery Performance and Battery Deformation Rate

The manufactured separator between a positive electrode and a negative electrode was used to assemble a pouch type battery in a stacking manner, and an electrolyte solution which was ethylene carbonate (EC)/ethyl methyl carbonate (EMC)/dimethyl carbonate (DMC)=3:5:2 (volume ratio) in which 1M lithium hexafluorophosphate (LiPF₆) was dissolved was injected into each of the assembled batteries to manufacture a lithium secondary battery. Thus, a pouch type lithium ion secondary battery having a capacity of 2 Ah was manufactured. Evaluation of the resistance (DC-IR) of the lithium secondary battery used a J-pulse (Japan Electric Vehicle Association Standards, JEVS D 713) method which evaluates 10 seconds discharge and charge characteristics at 0.25 C, 0.5 C, 1.0 C, 1.5 C, 2.0 C, and 2.5 C. The average impedance of three batteries was calculated by the above method to calculate an initial resistance value and the standard deviation thereof. A relative value of the initial resistance refers to an increased value as compared with the initial resistance of an uncoated porous substrate (Comparative Example 2).

$$Relative comparison with Ref . ( \% ) = ( ( Impedance - {Impedance}_{substrate} ) / {Impedance}_{substarte} ) \times 100$$

In the case of a cyclic life, after charging/discharging at 0.5 C 100 times, the impedance was calculated by J-pulse as in the method of measuring the initial resistance, thereby calculating the average and the standard deviation of the three. A resistance change after charging/discharging 100 times, calculation was performed as follows:

$$Relative changes in impedance ( \% ) = ( ( {Impedance}_{100 cycles} - {Impedance}_{initial} ) / {Impedance}_{initial} ) \times 100$$

The battery deformation rate was calculated by measuring a thickness change of the battery after charging/discharging 100 times.

The thickness of the battery was obtained by measuring the thickness of the battery at 5 points (4 points of corners and 1 point of center) and calculating the average value.

$$Δ Th ( \% ) = ( ( Thn - Th 0 ) / Th 0 ) \times 100$$

wherein Th0 is an initial battery thickness, and Thn is a battery thickness measured after charging/discharging the secondary battery 100 times.

### 7) Average Particle Diameter and Average Outer Diameter

Average particle diameter (D50), D10, and D90 were measured using S3500 available from Microtrac which is a particle size analyzer, in accordance with the ISO 13320-1 standard.

### Example 1

3 parts by weight of polyacrylamide (Mw 150,000 g/mol, Sigma Aldrich) with respect to 100 parts by weight of boehmite (γ-AlO(OH)) having an average particle diameter of 300 nm was added to water, and 0.7 parts by weight of a dispersing agent (BYK-2018) was added and stirred, thereby preparing a uniform water-based slurry having a solid content of 30 wt %. 1 part by weight of hollow acryl particles having an average outer diameter of 0.9 μm and a hollow rate of 78% which were prepared according to Example 5 of Korean Patent Laid-Open Publication No. 2020-138213A (publication date: Dec. 9, 2020) with respect to boehmite was added, and water was further added, thereby preparing a slurry composition having a final solid content of 25 wt %. The prepared slurry composition, as a water-based slurry, was coated on both surfaces of a polyolefin microporous film having a thickness of 9 μm (ENPASS, SK Innovation, average pore size: 40 nm) as a substrate using bar coating at a speed of 10 m/min, and then dried with hot air at 45° C. The drying was performed until there was no more weight loss. Then, winding was carried out. The thickness of the double-sided coating layer after drying was 3.0 μm, respectively. The physical properties of the manufactured separator were evaluated and are listed in Table 1, and the manufactured separator was used to evaluate cell physical properties which are listed in Table 2.

The manufactured separator was observed using an energy dispersive spectrometer (EDS) attached to a scanning electron microscope (SEM), and as a result, it was confirmed that hollow acryl particles floated on the surface to form an adhesive layer.

### Example 2

The process was performed in the same manner as in Example 1, except that the slurry composition was applied on one surface of a polyolefin microporous film fixed to a glass plate having a size of 0.2 m×0.2 m using bar coating and allowed to stand for 3 minutes, ultrasonic vibration was applied to the glass plate, drying with hot air at 45° C. until there was no more weight loss. This coating process was repeated on the other surface, so that one coating was applied on each side. The physical properties of the manufactured separator were evaluated and are listed in Table 1, and the manufactured separator was used to evaluate cell physical properties which are listed in Table 2.

The manufactured separator was observed using EDS attached to the scanning electron microscope (SEM), and as a result, it was confirmed that hollow acryl particles floated on the surface to form an adhesive layer. In addition, it was confirmed that more hollow acryl particles floated on the surface than Example 1.

### Example 3

The process was performed in the same manner as in Example 1, except that 2 parts by weight of the hollow acryl particles with respect to boehmite were added. The physical properties of the manufactured separator were evaluated and are listed in Table 1, and the manufactured separator was used to evaluate cell physical properties which are listed in Table 2.

### Example 4

The process was performed in the same manner as in Example 1, except that 5 parts by weight of the hollow acryl particles with respect to boehmite were added. The physical properties of the manufactured separator were evaluated and are listed in Table 1, and the manufactured separator was used to evaluate cell physical properties which are listed in Table 2.

### Comparative Example 1

A slurry was prepared in the same manner as in Example 1, except that the hollow acryl particles were not used, and a separator was manufactured in the same manner as in Example 1. The physical properties of the manufactured separator were evaluated and are listed in Table 1, and the manufactured separator was used to evaluate cell physical properties which are listed in Table 2.

### Comparative Example 2

The physical properties of the polyolefin microporous film (ENPASS, SK Innovation, average pore size: 40 nm) used in Example 1 were evaluated, and are shown in the following Table 1. That is, the physical properties of the polyolefin microporous film itself were measured without forming the coating layer and are shown in Table 1, and the physical properties of a cell using the film were measured and are listed in Table 2:

TABLE 1

| | | | | | | Electrode adhesiveness | | |
|---|---|---|---|---|---|---|---|---|
| | Thicknesses | | | | | Peeling Test | | |
| | of Coating | Heat shrinkage | | | | Negative | Positive | Stacking |
| | layer | (TD %) | | | | electrode | electrode | adhesiveness |
| | μm | 130° C. | 150° C. | 170° C. | sec/100 cc | gf/15 mm | | (1~6EA) |
| Example 1 | 3/3 | 1.1 | 1.9 | 2.2 | 27 | 1.2 | 1.2 | 6 |
| Example 2 | 3/3 | 1.1 | 1.9 | 2.2 | 27 | 1.5 | 1.5 | 6 |
| Example 3 | 3/3 | 1.4 | 3.2 | 4.1 | 26 | 1.9 | 2.5 | 6 |
| Example 4 | 3/3 | 1.7 | 7.4 | 7.9 | 22 | 3.8 | 3.7 | 6 |
| Comparative | 3/3 | 1.1 | 1.8 | 2.1 | 31 | 0.2 | 0.2 | 1 |
| Example 1 | | | | | | | | |
| Comparative | 0/0 | 6.9 | 56 | 62 | 0 | 0.1 | 0.1 | 0 |
| Example 2 | | | | | | | | |

TABLE 2

| | Impedance | | | Impedance | | | |
|---|---|---|---|---|---|---|---|
| | Initial | | | 100th cycle | | | |
| | | Standard | Relative | | | Relative | Relative changes |
| | Average | deviation | comparison | Average | STD | changes in | in cell thickness |
| | (mΩ) | (STD)(mΩ) | with Ref. (%) | (mΩ) | (mΩ) | impedance (%) | (%) |
| Example 1 | 27.82 | 0.43 | 4.0 | 32.70 | 0.80 | 17.5 | 1.2 |
| Example 2 | 27.99 | 0.34 | 4.6 | 32.39 | 0.61 | 15.7 | 1.2 |
| Example 3 | 27.69 | 0.36 | 3.5 | 32.18 | 0.62 | 16.2 | 1.0 |
| Example 4 | 28.01 | 0.33 | 4.7 | 32.74 | 0.58 | 16.9 | 1.0 |
| Comparative | 27.86 | 0.48 | 4.1 | 35.69 | 0.93 | 28.1 | 5.2 |
| Example 1 | | | | | | | |
| Comparative | 26.76 | 0.28 | 0.0 | 34.55 | 0.99 | 29.1 | 5.6 |
| Example 2 | | | | | | | |

The separator based on an example embodiment of the disclosed technology includes hollow adhesive particles, and has improved surface adhesive strength considering the content of the hollow adhesive particles, so that it may be adhered to an electrode with high adhesive strength.

In addition, the method for manufacturing a separator based on an example embodiment of the disclosed technology may easily produce a separator having improved adhesive strength to an electrode only by forming a coating layer on a porous substrate.

In addition, the secondary battery including the separator based on an example embodiment of the disclosed technology has improved adhesive strength between an electrode and a separator to allow a higher capacity and a larger size, and may have substantially very high industrial applicability.

In addition, in an example embodiment of the disclosed technology, a new separator which has ability to internally accommodate swelling by an electrolyte and the like while providing an excellent adhesive function between a separator and an electrode may be provided.

In addition, in an example embodiment of the disclosed technology, a new separator which has a buffer function to internally accommodate swelling by an electrolyte to suppress swelling and also prevents an adhesive from eluting into an electrolyte by an electrolyte may be provided.

In addition, in an example embodiment of the disclosed technology, since swelling is suppressed to maintain adhesive strength to an electrode, that is, loss of adhesive strength by swelling is prevented, a new separator which maintains the alignment of an electrode module well even when many electrodes and separators are stacked, and a battery using the same may be provided.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs).

Only a few implementations and examples are described and other implementations, enhancements and variations can be made based on what is described and illustrated in this patent document.

What is claimed is:

1. A separator comprising:
a porous substrate including a first surface and a second surface; and
a coating layer disposed on at least one of the first surface or the second surface of the porous substrate and including inorganic particles and hollow adhesive particles.

2. The separator of claim 1, wherein a surface of the coating layer facing the porous substrate corresponds to as a first surface, and an opposite surface of the first surface corresponds to as a second surface, and the second surface has a higher content of the hollow adhesive particles than the first surface.

3. The separator of claim 2, wherein the coating layer has a gradient in which the content of the hollow adhesive particles increases from the first surface toward the second surface.

4. The separator of claim 3, wherein the coating layer includes: an inorganic particle layer including the inorganic particles; and an adhesive layer formed by the hollow adhesive particles floating on the inorganic particle layer.

5. The separator of claim 1, wherein the coating layer includes one or more stacked layers.

6. The separator of claim 1, wherein the hollow adhesive particles have a hollow rate of 5 to 97%.

7. The separator of claim 1, wherein the hollow adhesive particles have an average outer diameter of 10 nm to 10 μm.

8. The separator of claim 1, wherein each of the hollow adhesive particles includes: a hollow core that includes an empty inner space; and a shell layer including an adhesive material, wherein the adhesive material includes an adhesive resin that has adhesive strength at room temperature or higher or at a glass transition temperature or higher.

9. The separator of claim 8, wherein the adhesive resin includes at least one of an acryl-based resin, a fluorine-based resin, an amide-based resin, a copolymer of two or more of the acryl-based resin, the fluorine-based resin, and the amide-based resin, or a mixture of two or more of the acryl-based resin, the fluorine-based resin, and the amide-based resin.

10. The separator of claim 9, wherein the adhesive resin is crosslinked.

11. The separator of claim 8, wherein each of the hollow adhesive particles further includes a structure material layer configured to maintain the hollow core under the shell layer.

12. The separator of claim 1, further comprising: an inorganic particle layer between the porous substrate and the coating layer.

13. A method for manufacturing a separator, the method comprising:
forming a coating layer by applying a coating composition that includes inorganic particles and hollow adhesive particles onto at least one of a first surface or a second surface of a porous substrate; and
drying the coating layer.

14. The method for manufacturing a separator of claim 13, further comprising: applying vibration before drying the coating layer or applying vibration while drying the coating layer.

15. The method for manufacturing a separator of claim 13, further comprising: allowing the separator onto which the coating composition is applied to stand before drying the coating layer.

16. The method for manufacturing a separator of claim 13, wherein the coating layer has a gradient formed by the hollow adhesive particles floating on a surface of the coating layer after applying the coating composition and drying the coating layer, or includes an adhesive layer that includes the hollow adhesive particles formed on the surface of the coating layer.

17. The method for manufacturing a separator of claim 13, wherein the coating composition has a solid content of 10 to 60 wt %.

18. The method for manufacturing a separator of claim 13, wherein the coating composition includes 0.2 to 20 parts by weight of the hollow adhesive particles with respect to 100 parts by weight of the inorganic particles.

19. The method for manufacturing a separator of claim 13, wherein the drying is performed by hot air at 25 to 100° C.

20. A secondary battery comprising a separator that includes:
a porous substrate including a first surface and a second surface; and
a coating layer disposed on at least one of the first surface or the second surface of the porous substrate and including inorganic particles and hollow adhesive particles.

21. A method for manufacturing a secondary battery, the method comprising:
placing a separator between a positive electrode and a negative electrode; and
applying heat, pressure, or heat with pressure to integrate the separator and the electrodes,
wherein the separator includes:
a porous substrate including a first surface and a second surface; and
a coating layer disposed on at least one of the first surface or the second surface of the porous substrate and including inorganic particles and hollow adhesive particles.
